(19) United States
(12) Patent Application Publication
(10) Pub. No.: US 2025/0272481 A1
(43) Pub. Date: Aug. 28, 2025

(54) METHOD AND SYSTEM FOR TRANSFORMING STRUCTURED DOCUMENTS INTO DIGESTIBLE INPUT DATA

(71) Applicant: JPMorgan Chase Bank, N.A., New York, NY (US)

(72) Inventors: Ran ZMIGROD, Cambridge (GB); Zhiqiang MA, Short Hills, NJ (US); Ranier MOORE, Philadelphia, PA (US); Rossi MENA, Newark, DE (US); Armineh NOURBAKHSH, Pittsburgh, PA (US); Xiaomo LIU, Manhasset, NY (US)

(73) Assignee: JPMorgan Chase Bank, N.A., New York, NY (US)

(21) Appl. No.: 18/584,701

(22) Filed: Feb. 22, 2024

(51) Int. Cl. G06F 40/186; G06T 5/70; G06T 7/33

(52) U.S. Cl. CPC G06F 40/186; G06T 5/70; G06T 7/337; G06T 2207/30176

(57) ABSTRACT

A system is provided for implementing a document image transformation tool that transforms an image of at least one physical document into digestible data. The system stores instructions that cause a processor to: generate a first template definition of a first type of document; transform, based on the template definition, the image of the at least one physical document into a transformed image of the at least one physical document; produce, based on the template definition, input data from the transformed image of the at least one physical document; compute, based on the transforming and the producing, analytics that identify at least one parameter of a result of the transforming and the producing; associate, via an association, the input data with the analytics; and digest at least one from among the input data, the analytics, and the association.

### BACKGROUND

### 1. Field of the Invention

The field of the invention disclosed herein generally relates to a document image transformation tool and, more particularly, to a method, system, and computer-readable medium for implementing technology that transforms images of at least one physical document into digestible input data, thereby improving the speed, accuracy, efficiency, and ease of use of existing technological approaches to digesting such documents.

### 2. Background of the Invention

Existing technology for digesting images of at least one physical document is inflexible and sensitive to unexpected input because conventional approaches to such technology are only capable of processing input that meets very specific criteria. For example, current technology cannot digest unexpected input, such as a rotated, incomplete or distorted view of a document or unexpected types of documents, for example.

Conventional technology is also incapable of digesting more than one type of document because existing approaches to such operations are tailored to very specific purposes and have little to no utility outside of the scope of such purposes. As a result, such bespoke systems usually come with high resource costs.

Unfortunately, for the various applications of such document digestion technology, these drawbacks are not user-friendly and are prone to issues that require either technical support or some other form of manual intervention. Accordingly, existing systems for digesting an image of a physical document are unreliable and difficult to use.

Therefore, there is a need in the field of the herein-disclosed invention for a technical solution to the foregoing limitation(s) in the technology of existing approaches for digesting images of at least one physical document.

### SUMMARY

The present disclosure, through one or more of its various aspects, embodiments, and/or specific features or sub-component, provides, inter alia, various systems, servers, devices, methods, media, programs and platforms for implementing a document image transformation tool that transforms images of at least one physical document into digestible input data.

According to an aspect of the present disclosure, a method is provided for implementing a document image transformation tool that transforms an image of at least one physical document into digestible data. The method may comprise: generating a first template definition of a first type of document; transforming, based on the template definition, the image of the at least one physical document into a transformed image of the at least one physical document; producing, based on the template definition, input data from the transformed image of the at least one physical document; computing, based on the transforming and the producing, analytics that identify at least one parameter of a result of the transforming and the producing; associating, via an association, the input data with the analytics; and digesting at least one from among the input data, the analytics, and the association. The image of the at least one physical document may comprise the first type of document.

In the method, the transforming may comprise performing at least one from among noise reduction and noise elimination, on the image of the at least one physical document in order to produce the transformed image of the at least one physical document.

In the method, the first template definition may comprise at least one from among a set of document anchors, a set of visual key points, and a set of field types.

In the method, the transforming may comprise utilizing the set of document anchors and the set of visual key points, to align the image with a template of the first type of document. The template of the first type of document may comprise a plurality of fields and a plurality of bounding boxes that respectively correspond to the plurality of fields.

In the method, the producing may comprise a conversion that generates the input data based on a plurality of excerpts from the image. The plurality of excerpts from the image may be respectively defined by the plurality of bounding boxes.

In the method, the conversion may generate the input data based on the set of field types.

In the method, at least one corresponding artificial intelligence and machine learning (AI/ML) model may be trained to perform the at least one from among the generating, the transforming, the producing, the computing, the associating, and the digesting, respectively.

In the method, the analytics may comprise at least one from among at least one transformation magnitude, at least one transformation type, at least one transformation quality, and at least one transformation crossover.

In the method, the digestible data may comprise at least one from among the input data, the extraction analytics, and the association.

The method may further comprise utilizing a plurality of template definitions to transform a plurality of images of corresponding physical documents that respectively comprise a plurality of document types. The utilizing may comprise performing at least one from among the generating, the transforming, the producing, the computing, the associating, and the digesting. The plurality of template definitions may comprise the first template definition and may respectively correspond to the plurality of document types.

According to another aspect of the present disclosure, a system is provided for implementing a document image transformation tool that transforms an image of at least one physical document into digestible data. The system comprising a processor and memory storing instructions that, when executed by the processor, cause the processor to perform operations. The operations may comprise: generating a first template definition of a first type of document; transforming, based on the template definition, the image of the at least one physical document into a transformed image of the at least one physical document; producing, based on the template definition, input data from the transformed image of the at least one physical document; computing, based on the transforming and the producing, analytics that identify at least one parameter of a result of the transforming and the producing; associating, via an association, the input data with the analytics; and digesting at least one from among the input data, the analytics, and the association. The image of the at least one physical document may comprise the first type of document.

In the system, when executed by the processor, the instructions may cause the transforming to comprise performing at least one from among noise reduction and noise elimination, on the image of the at least one physical document in order to produce the transformed image of the at least one physical document.

In the system, when executed by the processor, the instructions may cause the first template definition to comprise at least one from among a set of document anchors, a set of visual key points, and a set of field types.

In the system, when executed by the processor, the instructions may cause the transforming to comprise utilizing the set of document anchors and the set of visual key points, to align the image with a template of the first type of document. The template of the first type of document may comprise a plurality of fields and a plurality of bounding boxes that respectively correspond to the plurality of fields.

In the system, when executed by the processor, the instructions may cause the producing to comprise a conversion that generates the input data based on a plurality of excerpts from the image. The plurality of excerpts from the image may be respectively defined by the plurality of bounding boxes.

In the system, when executed by the processor, the instructions may cause the conversion to generate the input data based on the set of field types.

In the system, when executed by the processor, the instructions may cause at least one corresponding AI/ML model to be trained to perform the at least one from among the generating, the transforming, the producing, the computing, the associating, and the digesting, respectively.

In the system, when executed by the processor, the instructions may cause the analytics to comprise at least one from among: at least one transformation magnitude, at least one transformation type, at least one transformation quality, and at least one transformation crossover.

In the system, when executed by the processor, the instructions may cause the digestible data to comprise at least one from among the input data, the extraction analytics, and the association.

In the system, when executed, the instructions may cause the processor to perform further operations that comprise: utilizing a plurality of template definitions to transform a plurality of images of corresponding physical documents that respectively comprise a plurality of document types. The utilizing may comprise performing at least one from among the generating, the transforming, the producing, the computing, the associating, and the digesting. The plurality of template definitions may comprise the first template definition and may respectively correspond to the plurality of document types.

According to yet another aspect of the present invention, a non-transitory computer-readable medium is provided for implementing a document image transformation tool that transforms an image of at least one physical document into digestible data. The computer-readable medium stores instruction that, when executed by a processor, cause the processor to perform operations. The operations may comprise: generating a first template definition of a first type of document; transforming, based on the template definition, the image of the at least one physical document into a transformed image of the at least one physical document; producing, based on the template definition, input data from the transformed image of the at least one physical document; computing, based on the transforming and the producing, analytics that identify at least one parameter of a result of the transforming and the producing; associating, via an association, the input data with the analytics; and digesting at least one from among the input data, the analytics, and the association. The image of the at least one physical document may comprise the first type of document.

In the computer-readable medium, when executed by the processor, the instructions may cause the transforming to comprise performing at least one from among noise reduction and noise elimination, on the image of the at least one physical document in order to produce the transformed image of the at least one physical document.

In the computer-readable medium, when executed by the processor, the instructions may cause the first template definition to comprise at least one from among a set of document anchors, a set of visual key points, and a set of field types.

In the computer-readable medium, when executed by the processor, the instructions may cause the transforming to comprise utilizing the set of document anchors and the set of visual key points, to align the image with a template of the first type of document. The template of the first type of document may comprise a plurality of fields and a plurality of bounding boxes that respectively correspond to the plurality of fields.

In the computer-readable medium, when executed by the processor, the instructions may cause the producing to comprise a conversion that generates the input data based on a plurality of excerpts from the image. The plurality of excerpts from the image may be respectively defined by the plurality of bounding boxes.

In the computer-readable medium, when executed by the processor, the instructions may cause the conversion generates the input data based on the set of field types.

In the computer-readable medium, when executed by the processor, the instructions may cause at least one corresponding AI/ML model to be trained to perform the at least one from among the generating, the transforming, the producing, the computing, the associating, and the digesting, respectively.

In the computer-readable medium, when executed by the processor, the instructions may cause the analytics to comprise at least one from among: at least one transformation magnitude, at least one transformation type, at least one transformation quality, and at least one transformation crossover.

In the computer-readable medium, when executed by the processor, the instructions may cause the digestible data to comprise at least one from among the input data, the extraction analytics, and the association.

In the computer-readable medium, when executed, the instructions may cause the processor to perform further operations that comprise: utilizing a plurality of template definitions to transform a plurality of images of corresponding physical documents that respectively comprise a plurality of document types. The utilizing may comprise performing at least one from among the generating, the transforming, the producing, the computing, the associating, and the digesting. The plurality of template definitions may comprise the first template definition and may respectively correspond to the plurality of document types.

Thereby, the invention disclosed herein improves the speed, accuracy, efficiency, and ease of use of existing technological approaches to digesting documents.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 depicts a diagram of an exemplary computer system.

FIG. 2 depicts a diagram of an exemplary network environment for transforming images of a physical document into digestible input data.

FIG. 3 depicts a diagram of an exemplary perspective of a network environment that transforms images of a physical document into digestible input data.

FIG. 4 depicts a flowchart of an exemplary process for transforming an image of a physical document into digestible input data.

FIG. 5 depicts a diagram of an exemplary document processing system.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

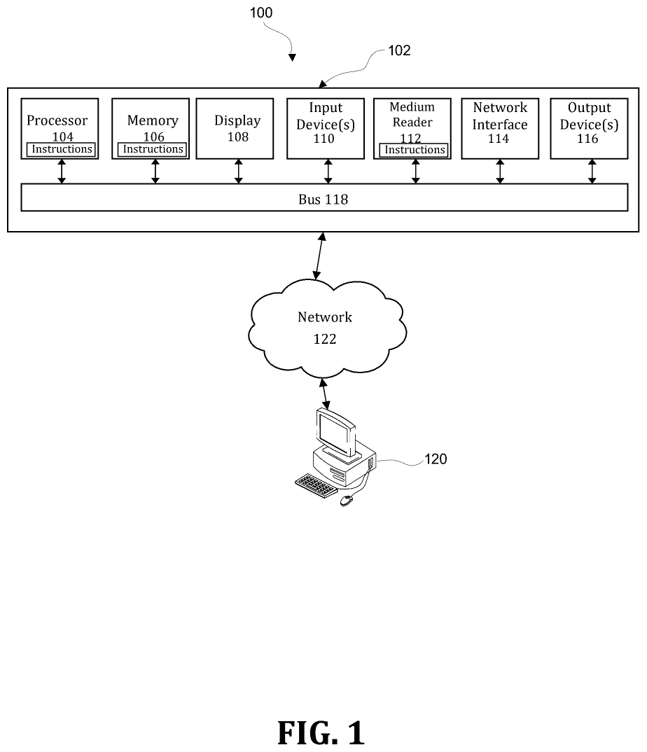

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing a document image transformation tool that transforms images of at least one physical document into digestible input data, thereby improving the speed, accuracy, efficiency, and ease of use of existing technological approaches to digesting such documents.

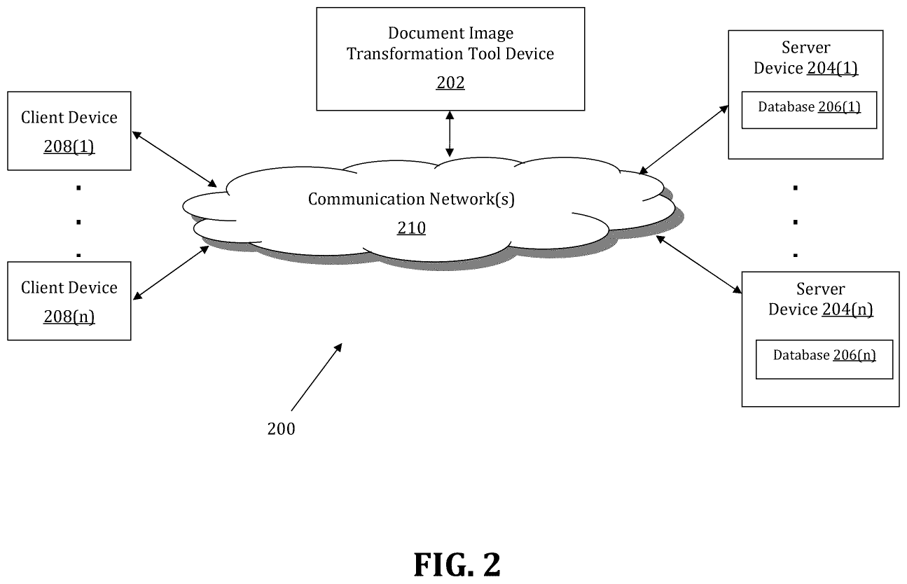

Referring to FIG. 2, a schematic of an exemplary network environment 200 for implementing a tool that transforms images of at least one physical document into digestible input data. In an exemplary embodiment, a document image transformation tool may be implemented on any networked computer platform, such as, for example, a personal computer (PC).

A method for implementing a tool that virtually that transforms images of at least one physical document into digestible input data, may be implemented by a Document Image Transformation Tool (DITT) device 202. The DITT device 202 may be the same or similar to the computer system 102 as described with respect to FIG. 1. The DITT device 202 may be a rack-mounted server in a datacenter, an embedded microcontroller (MCU) in an electronic device, or another type of headless system, which is a computer system or device that is configured to operate without a monitor, keyboard and mouse. The DITT device 202 may store one or more applications that can include executable instructions that, when executed by the DITT device 202, cause the DITT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DITT device 202 itself, may be located in virtual server(s) running in a cloud-based computing environment rather than being tied to one or more specific physical network computing devices. Also, the application(s) may be running in one or more virtual machines (VMs) executing on the DITT device 202. Additionally, in one or more embodiments of this technology, virtual machine(s) running on the DITT device 202 may be managed or supervised by a hypervisor.

In the network environment 200 of FIG. 2, the DITT device 202 is coupled to a plurality of server devices 204(1)-204(n) that hosts a plurality of databases 206(1)-206(n), and also to a plurality of client devices 208(1)-208(n) via communication network(s) 210. A communication interface of the DITT device 202, such as the network interface 114 of the computer system 102 of FIG. 1, operatively couples and communicates between the DITT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DITT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and DITT devices that implement a method for a document image transformation tool that improves the speed, accuracy, efficiency, and ease of use of existing technology for digesting documents.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DITT device 202 may be a standalone device or integrated with one or more other devices or apparatuses, such as one or more of the server devices 204(1)-204(n), for example. In one particular example, the DITT device 202 may include or be hosted by one of the server devices 204(1)-204(n), and other arrangements are also possible. As another example, the DITT device 202 may be integrated with one or more other devices or apparatuses, such as one or more of the client devices 208(1)-208(n). Moreover, one or more of the devices of the DITT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DITT device 202 via the communication network(s) 210 according to an HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DITT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DITT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DITT device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DITT device 202, the server devices 204(1)-204(n), the databases 206(1)-206(n), or the client devices 208(1)-208(n), for example, may be configured to operate as virtual instances on the same physical machine. In other words, one or more of the DITT device 202, the server devices 204(1)-204(n), the databases 206(1)-206(n), or the client devices 208(1)-208(n) may operate on the same physical device rather than as separate devices communicating through communication network(s) 210. Additionally, there may be more or fewer server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

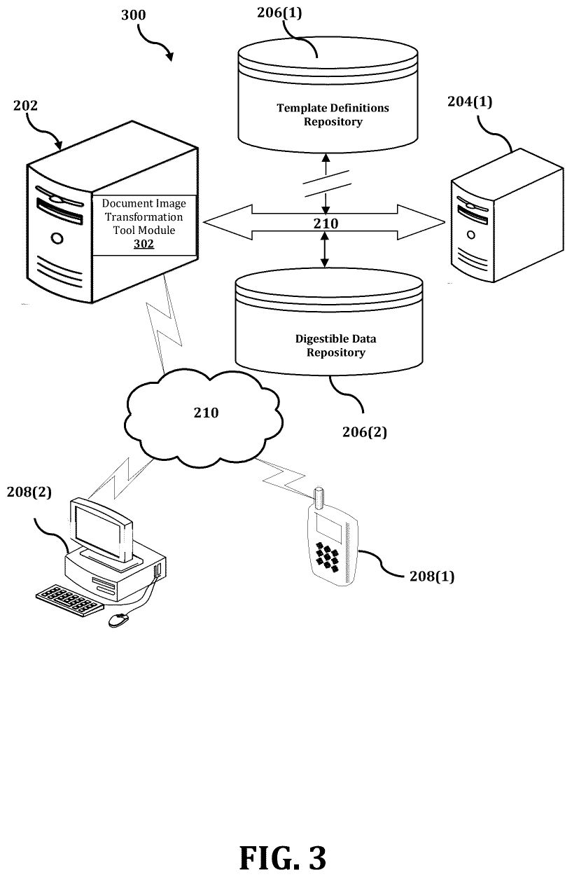

The DITT device 202 is described and illustrated in FIG. 3 as including document image transformation tool module 302, although it may include other rules, policies, modules, databases, or applications, for example. As will be described below, document image transformation tool module 302 is configured to transform an image of at least one physical document into digestible input data, and thereby improve the speed, accuracy, efficiency, and ease of use of existing technological approaches to digesting such documents. Document image transformation tool module 302 may include software that is based on a microservices architecture.

Document image transformation tool module 302 may be integrated with one or more devices or apparatuses, such as client devices 208(1)-208(n), where document image transformation tool module 302 may be implemented as an application or as an addon or plugin to another application of the one or more devices or apparatuses, and where document image transformation tool module 302 may execute in the background.

An exemplary process 300 for application of a document image transformation tool to an aspect of the network environment of FIG. 2 is illustrated as being executed in FIG. 3. Specifically, a first client device 208(1) and a second client device 208(2) are illustrated as being in communication with DITT device 202. In this regard, the first client device 208(1) and the second client device 208(2) may be “clients” of the DITT device 202 and are described herein as such. Nevertheless, it is to be known and understood that the first client device 208(1) and/or the second client device 208(2) need not necessarily be “clients” of the DITT device 202, or any entity described in association therewith herein. Any additional or alternative relationship may exist between either or both of first client device 208(1), second client device 208(2) and DITT device 202, or no relationship may exist.

Further, DITT device 202 is illustrated as being able to access template definitions repository 206(1), and digestible data repository 206(2). DITT device 202 may comprise document image transformation tool module 302, which communicates with template definitions repository 206(1). In addition, document image transformation tool module 302 of DITT device 202 may also communicate with digestible data repository 206(2). Document image transformation tool module 302 may be configured to provide a dynamically customizable interface for transforming images of at least one physical document into digestible input data.

Moreover, DITT device 202 may receive and transmit data via communication network(s) 210. DITT device 202 may receive and transmit data such as code that is written in one or more of the following dialects: transaction control language (TCL), data manipulation language (DML), data control language (DCL) and data definition language (DFL). Additionally, via communication network(s) 210, DITT device 202 may respectively receive and transmit data from and to one or more from among the following devices: server device 204, template definitions repository 206(1), digestible data repository 206(2) (or another database 206), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the DITT device 202 via broadband or cellular communication. Of course, these embodiments are merely exemplary and are not limiting or exhaustive.

Document image transformation tool module 302 provides a highly adaptable authentication framework that transforms images of at least one physical document into digestible input data. Moreover, document image transformation tool module 302 improves the speed, accuracy, efficiency, and ease of use of existing technological approaches to digesting documents.

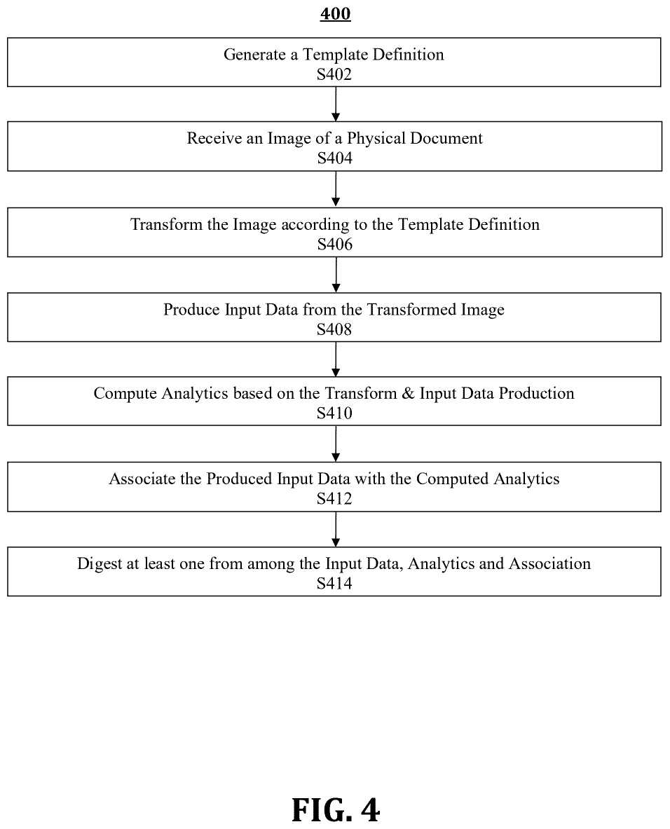

Document image transformation tool module 302 may execute a process that transforms images of at least one physical document into digestible input data, thereby improving the speed, accuracy, efficiency, and ease of use of existing technological approaches to digesting such documents. An exemplary process for a document image transformation tool is generally indicated at flowchart 400 in FIG. 4. In an exemplary embodiment, process 400 may be utilized to process inputs that comprise structured documents, such as intake forms, tax forms, accounting forms, applicant forms, other types of forms, worksheets, and other types of structured documents, etc.

In process 400 of FIG. 4, at step S402, document image transformation tool module 302 generates a first template definition of at least one physical document. In an embodiment, at step S402, document image transformation tool module 302 may automatically generate the template definition. However, document image transformation tool module 302 may be utilized to generate the first template definition manually as well.

In an exemplary embodiment, document image transformation tool module 302 may be utilized to manually generate the first template definition via a client device, such as client device 208, for example. In a further embodiment, the first template definition may comprise at least one from among a set of document anchors, a set of visual key points, and a set of field types. However, the first template definition may also or alternatively comprise other information as well.

At step S404, document image transformation tool module 302 receives an image of at least one physical document. In an embodiment, document image transformation tool module 302 may receive the image of the at least one physical document from a client device, such as client device 208, for example. However, document image transformation tool module 302 may also receive the at least one physical document from other sources, such as server device 204, for example. Although process S400 depicts step S402 as preceding step S404, it should be noted that these steps (S402 and S404) are nevertheless interchangeable and may be performed in any order with respect to one another. In an exemplary embodiment, the at least one physical document comprises at least one structured document, such as intake forms, tax forms, accounting forms, applicant forms, other types of forms, worksheets, and other types of structured documents, etc.

At step S406, document image transformation tool module 302 transforms the at least one physical document into a transformed image of the at least one physical document, and document image transformation tool module 302 performs this transformation based on the template definition. In an embodiment, the transformation of step S406 may comprise performing at least one from among noise reduction and noise elimination, on the image of the at least one physical document in order to produce the transformed image of the at least one physical document.

In a further embodiment, the transformation of step S406 may additionally or alternatively comprise utilizing the set of document anchors and the set of visual key points, to align the image with a template of the first type of document. In the embodiment, the template of the first type of document may comprise a plurality of fields and a plurality of bounding boxes that respectively correspond to the plurality of fields.

At step S408, document image transformation tool module 302 utilizes the transformed image to produce input data that is based on the template definition. In an embodiment, at step S408, document image transformation tool module 302 may produce the input data by conducting a conversion that generates the input data based on a plurality of excerpts from the image.

In a further embodiment, the plurality of excerpts from the image may be respectively defined by the plurality of bounding boxes. In yet an even further embodiment, at step S408, the conversion may additionally (or alternatively) generate the input data based on the set of field types. For example, input data of a radio button field may merely indicate the presence or absence of an attribute, while a textual field's input data may comprise a set of textual strings (such as ASCII codes and/or even handwriting, for example).

At step S410, document image transformation tool module 302 computes analytics that are based on both step S406's transformation of the image into the transformed image and step S408's production of the input data based on the transformed image. In an embodiment, the analytics may comprise at least one from among: at least one transformation magnitude (e.g., a scaling magnitude, an amount of noise reduction, and/or a direction and amount of rotation, etc.), at least one transformation type (e.g., scaling, noise reduction, and/or rotate, etc.), at least one transformation quality (e.g., a confidence percentage/score and/or a resolution quality, etc.), and at least one transformation crossover (e.g., an indication of and/or an amount of document information that does not fall within a boundary of a particular transformation of the document information).

However, the analytics computed by document image transformation tool module 302, at step S410, may also or alternatively comprise other information as well. Accordingly, the analytics presented herein may identify at least one parameter of a result of both step S406 and step S408.

At step S412, document image transformation tool module 302 utilizes an association (e.g., a mapping, storage location, and/or corresponding AI/ML model, etc.) to associate the input data with the analytics. Subsequently, at step S414, document image transformation tool module 302 digests digestible data, and the digestible data may comprise at least one from among the input data, the analytics, and the association. However, in an embodiment, the digestible data may also or alternatively comprise other information as well.

In an embodiment, document image transformation tool module 302 may utilize at least one corresponding artificial intelligence and machine learning (AI/ML) model to perform at least one from among steps S402, S404, S4046, S408, S410, S412 and S414, respectively.

In the embodiment, corresponding training data may be utilized to train the at least one corresponding AI/ML model to perform the at least one from among steps S402, S404, S4046, S408, S410, S412 and S414. For example, at least one training dataset of noisy images of a physical document, may be utilized to train a noise reduction AI/ML model to perform step S406. In another example, at least one training dataset of images of at least one physical document that is at least partially filled, may be utilized to train a digestible data production AI/ML model to perform step S408. In yet another example, at least one training dataset of transformed images and/or at least one training dataset of input data production results, may be utilized to train an analytics computation AI/ML model to perform step S410.

In a further embodiment, document image transformation tool module 302 may respectively utilize a plurality of template definitions to transform a plurality of images of corresponding physical documents that respectively comprise a plurality of document types. Thereby, document image transformation tool module 302 may respectively utilize the plurality of template definitions with the plurality of images to perform at least one from among steps S402, S404, S4046, S408, S410, S412 and S414, respectively. Furthermore, the plurality of template definitions may comprise the template definition, and the plurality of template definitions may respectively correspond to the plurality of document types.

Accordingly, a general framework that offers a simple approach to producing input data based on a physical document is provided. In an embodiment, such a physical document may comprise, but is not limited to, a paper-based textual document, such as a tax form or questionnaire, for example. A template definition may be generated for each type of document from among a set of types of documents that are utilized by at least one downstream application of the herein disclosed framework.

A template definition of at least one type of document may comprise important information regarding a structural composition of at least one document type and may further comprise corresponding field information for the at least one document type. In an exemplary embodiment, each template definition may comprise a set of document anchors, a set of visual key points and a set of field types. However, the present framework may also or alternatively comprise other information as well.

In exemplary embodiments, document anchors may comprise at least one anchor word, which may comprise a word that may appear within a predetermined location of every instance of a particular type of document. In an embodiment, anchor words may be found throughout a particular type of document.

In such embodiments, visual key points may include at least one bounding box, which may comprise a rectangular area that may be denotes by the coordinates of its corners. In an embodiment, bounding boxes may be manually determined via a user interface that draws virtual boxes on a template of a particular type of document to identify corresponding fields within that document.

In further embodiments, a field type may describe a particular field within a document. For example, a set of field types may correspond to a set of fields within a document, respectively. In exemplary embodiments, field types may include, but are not limited to, at least one radio button (such as a checkbox) and at least one textual string (such as a handwritten signature).

In an exemplary embodiment of the document image transformation framework provided herein (such as document image transformation tool module 302, for example), an image may be received that may include a noisy image of a physical document. In the exemplary embodiment, the image may be characterized as noisy when it includes, for example, at least one from among a misaligned (e.g., rotated) image of the physical document, a blurry image of the physical document, a scaled (e.g., zooms) image of the physical document, etc. However, in other embodiments, the image may also be characterized as noisy when the image additionally or alternatively includes other imperfections (which may and/or may not arise from the physical document itself), transformations, conversions, and/or changes to the physical document.

In further embodiments of the document image transformation framework provided herein, a set of document anchors and a set of visual key points may be utilized to determine a set of transformations (e.g., rotations, zooms, etc.) that may be applied to remove noise from a noisy image. For example, the set of document anchors and the set of visual key points may initially be utilized to align the noisy image with a corresponding template of the type of document depicted within the noisy image.

In yet a further embodiment, at least one AI/ML model may be utilized to align a noisy image with a corresponding template of the type of document depicted within the noisy image. Such an AI/ML model may utilize platforms and the algorithms of such platforms, such as AI computer vision and its scale-invariant feature transform (SIFT) algorithm, for example.

In the document image transformation framework provided herein, a transformed image may be generated when a set of transformations that remove noise from a noisy image is applied to the noisy image. Subsequently, a series of AI/ML models may be utilized to determine a set of field types associated with the type of document depicted within the transformed image.

After a transformed image is generated by aligning a noisy image with a template that corresponds to its document's type, a plurality of bounding boxes may be utilized to define a plurality of excerpts that respectfully correspond to a plurality of fields within the document. Subsequently, the present framework may utilize the set of field types to produce input data based on the plurality of excerpts that respectfully correspond to the plurality of fields within the document.

In an exemplary embodiment, the set of field types respectively indicates whether a corresponding set of fields comprises a checkbox, radio button or character string (such ASCII or handwriting/handwritten signatures, for example). In further embodiments, each type of field may be utilized by a distinct AI/ML model to produce a corresponding type of input data that is based on each of a document's fields of that corresponding type.

For example, at least one first AI/ML model may process each of a document's checkbox fields to produce checkbox input data, at least one second AI/ML model may process each of the document's radio button fields to produce radio button input data, at least one third AI/ML model may process each of the document's ASCII fields to produce ASCII input data, at least one fourth AI/ML model may process each of the document's signature fields to produce signature input data (which may comprise handwritten signature input data), and at least one fifth AI/ML model may process each of the document's regular handwriting fields to produce handwritten input data.

In an embodiment, the at least one first AI/ML model may be trained to detect whether a bounding box of at least one corresponding checkbox field comprises a checkmark or an indication that the bounding box is filled. In an additional or alternative embodiment, the at least one second AI/ML model may also be trained to detect whether a bounding box of at least one radio button field comprises an indication that the bounding box is filled.

In another additional or alternative embodiment, the at least one third AI/ML model and/or the at least one fifth AI/ML model may each include their own distinct optical character recognition (OCR) feature that may produce respectively corresponding character strings. In yet another additional or alternative embodiment, the at least one fourth AI/ML model may be utilized to determine whether a signature lies within a bounding box of at least one corresponding signature field of a document.

According to various embodiments of the document image transformation framework provided herein, each component of the framework may further comprise a calibration module that may provide analytics on that component's operations/execution. In an exemplary embodiment, a component that may remove noise from a noisy image may provide noise reduction analytics that include at least one from among at least one transformation magnitude (e.g., a scaling magnitude, an amount of noise reduction, and/or a direction and amount of rotation, etc.), at least one transformation type (e.g., scaling, noise reduction, and/or rotation, etc.), at least one transformation quality (e.g., a confidence percentage/score and/or resolution quality, etc.), and at least one transformation crossover (e.g., an indication of and/or an amount of document information that does not fall within a boundary of a particular transformation of the document information).

Each calibration module within the document image transformation framework provided herein, may utilize at least one calibration technique, which may include at least one from among examining a magnitude of an alignment transformation, an OCR engine confidence, bounding box crossover (e.g., an indication of and/or an amount of field information that does not lie within its field's corresponding bounding box), and specific input data production quality metrics (e.g., a confidence score). In an exemplary embodiment, output from each calibration module may be aggregated to provide a set of calibration parameters that may be utilized to normalize a noisy image of at least one physical document.

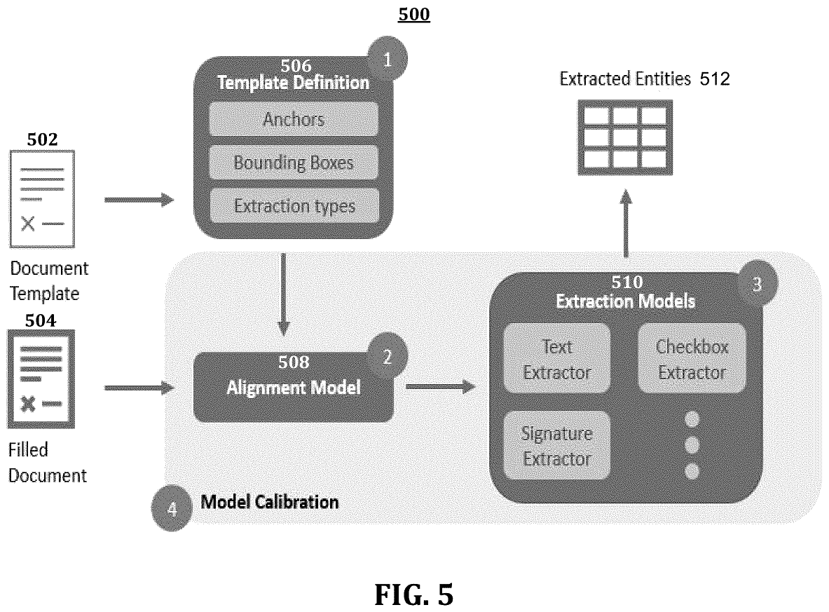

FIG. 5 depicts a diagram of a document processing system 500, which utilizes a plurality of document templates to process their respectively corresponding plurality of document types. As depicted in FIG. 5, document processing system 500 may utilize at least one document template (such as a first template definition) from among the plurality of document templates, which may be stored on a database, such as template definitions repository 206(1), for example.

In an embodiment, document processing system 500 may be a computer system such as computer system 102. In an initial (or first) function 1, document processing system 500 generates a document template 502 that is based on a template definition 506, which comprises a set of document anchors, a set of bounding boxes, and a set of extraction types.

In a subsequent (or second) function 2, alignment model 508 is trained to utilize template definition 506 to remove noise from (e.g., by realigning) an image of a document that has been at least partially completed, namely filled document 504. In a final (or third) function 3, extraction models 510 extract entities (namely, extracted entities 512) from an output of alignment model 508 via a text extractor module, a checkbox extractor module, and a signature module.

Accordingly, document processing system 500 may be utilized to improve the speed, accuracy, efficiency, and ease of use of existing technological approaches to extracting entities from at least one filled document.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for implementing a document image transformation tool that transforms an image of at least one physical document into digestible data, the method comprising:
generating a first template definition of a first type of document, wherein the image of the at least one physical document comprises the first type of document;
transforming, based on the template definition, the image of the at least one physical document into a transformed image of the at least one physical document;
producing, based on the template definition, input data from the transformed image of the at least one physical document;
computing, based on the transforming and the producing, analytics that identify at least one parameter of a result of the transforming and the producing;
associating, via an association, the input data with the analytics; and
digesting at least one from among the input data, the analytics, and the association.

2. The method of claim 1, wherein the transforming comprises performing at least one from among noise reduction and noise elimination, on the image of the at least one physical document in order to produce the transformed image of the at least one physical document.

3. The method of claim 1, wherein the first template definition comprises at least one from among a set of document anchors, a set of visual key points, and a set of field types.

4. The method of claim 3,
wherein the transforming comprises utilizing the set of document anchors and the set of visual key points, to align the image with a template of the first type of document, and
wherein the template of the first type of document comprises a plurality of fields and a plurality of bounding boxes that respectively correspond to the plurality of fields.

5. The method of claim 4,
wherein the producing comprises a conversion that generates the input data based on a plurality of excerpts from the image, and
wherein the plurality of excerpts from the image are respectively defined by the plurality of bounding boxes.

6. The method of claim 5, wherein the conversion generates the input data based on the set of field types.

7. The method of claim 1, wherein at least one corresponding artificial intelligence and machine learning (AI/ML) model is trained to perform the at least one from among the generating, the transforming, the producing, the computing, the associating, and the digesting, respectively.

8. The method of claim 1, wherein the analytics comprise at least one from among:
at least one transformation magnitude, at least one transformation type, at least one transformation quality, and at least one transformation crossover.

9. The method of claim 1, wherein the digestible data comprises at least one from among the input data, the extraction analytics, and the association.

10. The method of claim 1, further comprising:
utilizing a plurality of template definitions to transform a plurality of images of corresponding physical documents that respectively comprise a plurality of document types,
wherein the utilizing comprises performing at least one from among the generating, the transforming, the producing, the computing, the associating, and the digesting, and
wherein the plurality of template definitions comprises the first template definition and respectively corresponds to the plurality of document types.

11. A system for implementing a document image transformation tool that transforms an image of at least one physical document into digestible data, the system comprising:
a processor; and
memory storing instructions that, when executed by the processor, cause the processor to perform operations that comprise:
generating a first template definition of a first type of document, wherein the image of the at least one physical document comprises the first type of document;
transforming, based on the template definition, the image of the at least one physical document into a transformed image of the at least one physical document;
producing, based on the template definition, input data from the transformed image of the at least one physical document;
computing, based on the transforming and the producing, analytics that identify at least one parameter of a result of the transforming and the producing;
associating, via an association, the input data with the analytics; and
digesting at least one from among the input data, the analytics, and the association.

12. The system of claim 11, wherein when executed by the processor, the instructions cause the transforming to comprise performing at least one from among noise reduction and noise elimination, on the image of the at least one physical document in order to produce the transformed image of the at least one physical document.

13. The system of claim 11, wherein when executed by the processor, the instructions cause the first template definition to comprise at least one from among a set of document anchors, a set of visual key points, and a set of field types.

14. The system of claim 13, wherein when executed by the processor, the instructions cause the transforming to comprise utilizing the set of document anchors and the set of visual key points, to align the image with a template of the first type of document, wherein the template of the first type of document comprises a plurality of fields and a plurality of bounding boxes that respectively correspond to the plurality of fields.

15. The system of claim 14, wherein when executed by the processor, the instructions cause the producing to comprise a conversion that generates the input data based on a plurality of excerpts from the image, wherein the plurality of excerpts from the image are respectively defined by the plurality of bounding boxes.

16. The system of claim 15, wherein when executed by the processor, the instructions cause the conversion to generate the input data based on the set of field types.

17. A non-transitory computer-readable medium for implementing a document image transformation tool that transforms an image of at least one physical document into digestible data, wherein the computer-readable medium stores instruction that, when executed by a processor, cause the processor to perform operations comprising:
generating a first template definition of a first type of document, wherein the image of the at least one physical document comprises the first type of document;
transforming, based on the template definition, the image of the at least one physical document into a transformed image of the at least one physical document;
producing, based on the template definition, input data from the transformed image of the at least one physical document;
computing, based on the transforming and the producing, analytics that identify at least one parameter of a result of the transforming and the producing;
associating, via an association, the input data with the analytics; and
digesting at least one from among the input data, the analytics, and the association.

18. The computer-readable medium of claim 17, wherein when executed by the processor, the instructions cause the first template definition to comprise at least one from among a set of document anchors, a set of visual key points, and a set of field types.

19. The computer-readable medium of claim 18, wherein when executed by the processor, the instructions cause the transforming to comprise utilizing the set of document anchors and the set of visual key points, to align the image with a template of the first type of document,
wherein the template of the first type of document comprises a plurality of fields and a plurality of bounding boxes that respectively correspond to the plurality of fields.

20. The computer-readable medium of claim 19, wherein when executed by the processor, the instructions cause the producing to comprise a conversion that generates the input data based on a plurality of excerpts from the image, wherein the plurality of excerpts from the image are respectively defined by the plurality of bounding boxes.
